(19) United States
(12) Patent Application Publication
(10) Pub. No.: US 2026/0342610 A1
(43) Pub. Date: Oct. 29, 2026

(54) METHOD FOR INITIALIZING AN AUTOMATION NETWORK, REPLACEMENT BUS SUBSCRIBER, AND AUTOMATION NETWORK

(71) Applicant: Beckhoff Automation GmbH, Verl (DE)

(72) Inventors: Timo Ottersberg, Rietberg (DE); Michael Jost, Dörentrup (DE); Martin Podrouschek, Halle (DE); Holger Büttner, Berlin (DE); Dirk Janssen, Verl (DE); Florian Essler, Augsburg (DE)

(21) Appl. No.: 19/703,656

(22) Filed: Jun. 10, 2026

Related U.S. Application Data
(63) Continuation of application No. PCT/EP2024/085652, filed on Dec. 11, 2024.

(30) Foreign Application Priority Data
Dec. 19, 2023 (DE) 10 2023 135 813.8

(51) Int. Cl. H04L 12/40; H04L 41/0686; H04L 41/0816

(52) U.S. Cl. CPC H04L 12/40032; H04L 41/0686; H04L 41/0816; H04L 12/40169; H04L 2012/4026

(57) ABSTRACT

In a method for initializing an automation network having a plurality of bus subscribers, the identification object assigned to each bus subscriber is compared in a target configuration with an identification object read out from the bus subscriber. If a deviation exists between the identification objects, it is determined on the basis of a type identifier read out from the bus subscriber whether the bus subscriber is a replacement bus subscriber. If the type identifier indicates that the bus subscriber is a replacement bus subscriber, a replacement list read out from the bus subscriber is used to determine whether the original bus subscriber can be replaced by the replacement bus subscriber. An error state is triggered and the initialization is aborted if no permitted actual configuration is found when determining the actual configuration.

### CROSS-REFERENCE TO RELATED APPLICATIONS

The present patent application is a continuation of International Patent Application No. PCT/EP2024/085652, filed Dec. 11, 2024, entitled “Method for Initializing an Automation Network, Substitute Bus User, and Automation Network,” which claims the priority of German patent application DE 10 2023 135 813.8, filed Dec. 19, 2023, entitled “Verfahren zur Erkennung, Konfiguration und Aktivierung einer Funktion eines Austausch-Busteilnehmers in einem Automatisierungsnetzwerk, Busteilnehmer, Austausch-Busteilnehmer und Automatisierungsnetzwerk,” each of which is incorporated by reference herein, in its entirety and for all purposes.

### FIELD

The invention relates to a method for initializing an automation network. The method is used to detect, configure, and activate a function of a replacement bus subscriber in an automation network. The invention also relates to a replacement bus subscriber for an automation network, to an automation network, and to a bus subscriber that is embodied to detect, configure, and/or activate a function of the replacement bus subscriber.

### BACKGROUND

Field-bus systems, the message transmission of which is based on the Ethernet protocol, are often operated in the form of a control bus subscriber, i.e., a central controller or a main device, and a subordinate bus subscriber or a subordinate unit in a system or machine, which is controlled by the control bus subscriber. The control bus subscriber is the central controller that has bus access authorization and may output data to the field bus. The subordinate bus subscribers or subordinate units in the field-bus system are the field devices, such as I/O devices, drives, transducers, etc. They do not have bus access authorization and may only acknowledge received data and transmit data upon request by the control bus subscriber.

In this context, the control bus subscriber may, for example, form a so-called MainDevice (abbreviated MDevice) and the subordinate bus subscriber may, for example, form a SubordinateDevice (abbreviated SubDevice). In other words, the control bus subscriber may dictate the communication behavior of the subordinate bus subscriber.

In automation systems, a programmable logic controller (PLC) usually carries out control processes cyclically in order to generate output data for subordinate bus subscribers and/or other subordinate bus subscribers on the basis of input data from subordinate bus subscribers, which are then sent by the control bus subscriber.

After completing a cyclic control process of the PLC, the control bus subscriber sends the output data in the form of Ethernet data packets or Ethernet frames (also referred to as Ethernet telegrams) via the field bus, wherein the subordinate bus subscribers extract the output data assigned to the respective subordinate bus subscriber from the Ethernet data packets and execute a local subscriber process with this output data. The data determined by the local subscriber process is then transmitted by the subordinate bus subscriber to the control bus subscriber and subsequently transmitted and used by the control bus subscriber as input data for one of the next cyclic control processes of the PLC. In this context, the subordinate bus subscriber enters the input data into a telegram sent by the control bus subscriber.

When using the real-time capable EtherCAT protocol in the context of a control bus subscriber and subordinate bus subscriber system, the Ethernet data packets in which the EtherCAT datagrams are embedded are processed by the subordinate bus subscribers in passing. Each subordinate bus subscriber on the field bus is assigned its own data block area in the payload area of the Ethernet data packet.

Instead of a master bus-subscriber-subordinate-bus-subscriber system, a field-bus system may also be operated with a provider-consumer model. In the provider-consumer model, each subscriber, i.e., both the master bus subscriber and the subordinate bus subscribers (field devices on the field bus), offers data that may be requested by one or a plurality of of the other bus subscribers. The data is provided cyclically. The real-time capable PROFINET protocol, for example, uses the provider-consumer model for Ethernet data packet replacement. The data in the payload area of the Ethernet data packet is then intended for the consumer bus subscriber specified in the target address.

The individual bus subscribers in the automation network may be identified for the various transmission protocols and access methods-regardless of the hierarchical structure of the automation network-via the so-called identification object of a bus subscriber. The identification object, also referred to as “identity object,” forms a first communication object that comprises one or a plurality of data fields for identifying a bus subscriber. The first data field of the identification object may be embodied as a product identifier (known as a “product code”) for the bus subscriber, the second data field of the identification object may be embodied as a version number (known as a “revision number”) for the bus subscriber, and the third data field may be embodied as a manufacturer identifier (known as a “vendor ID”) for the bus subscriber. In addition, a fourth data field may form a serial number. The first to fourth data fields may each comprise UINT32 values. The version number may have a first data word (“Lo-Word,” bits 0-15) and a second data word (“Hi-Word,” bits 16-31).

However, for the above-mentioned identification of a bus subscriber in the automation network, only the first to third data fields of the identification object are preferably used, i.e., the product identifier, the version number, and the manufacturer identifier.

Due to delivery problems or the discontinuation of electronic components, e.g., chips (semiconductor technology), it may happen that circuit components of a bus subscriber are replaced by others, which then often have additional functionalities to those of the bus subscriber originally to be replaced, i.e., of the original bus subscriber, and/or are intended to replace a plurality of original bus subscribers. The bus subscribers whose circuit components have been replaced by others form so-called “replacement” bus subscribers or so-called “replace bus subscribers.” In other words, a replacement bus subscriber is embodied to functionally replace at least one original bus subscriber but may have a larger range of functions than the original bus subscriber.

A replacement bus subscriber may differ from an original bus subscriber, for example, in the product identifier and/or the first data word of the version number. As a result, the actual configuration of the automation network does not match the target configuration of the automation network. The target configuration may correspond to a digital description of the automation network with a plurality of bus subscribers. This means that the target configuration may form a digital description of the field-bus topology of the automation network: line, ring, tree, etc., the sequence of bus subscribers connected to the field bus, the configuration data of the bus subscribers, a table with identification objects of the bus subscribers, etc. The digital description may be implemented, for example, as a digital description file or similar. The actual configuration may form a real description of the automation network, i.e., an initial situation of the field-bus topology and the bus subscribers physically connected to the field bus, their real configuration data, etc. The actual configuration may be recorded, for example, by reading or extracting information from the individual bus subscribers by a control bus subscriber, thus recording the individual bus subscribers.

In automation technology, field-bus systems may basically be divided up into systems in which, for example, a control bus subscriber actively reads out the above-mentioned identification of the subordinate bus subscribers (recording of the above-mentioned actual configuration of the automation network) and systems in which, for example, the subordinate bus subscribers independently check the above-mentioned identification and, as the case may be, send a confirmation to the control bus subscriber. In the latter case, the control bus subscriber does not actively read out any identification of the subordinate bus subscribers.

Particularly in the case in which the control bus subscriber actively reads out the identification of the subordinate bus subscribers, i.e., records the above-mentioned actual configuration of the automation network, a subordinate bus subscriber the circuit components of which have been replaced by others as mentioned above, i.e. a subordinate replacement bus subscriber, may differ from an original bus subscriber in terms of the product identifier and/or the first data word of the version number. It is also conceivable that the second data word of the version number of a replacement bus subscriber differs from the second data word of the version number of an original bus subscriber. It is also conceivable that the manufacturer ID may differ between the original bus subscriber and the replacement bus subscriber. This is the case, for example, if the replacement bus subscriber comes from a different manufacturer than the original bus subscriber.

During the initializing phase of the automation network, e.g., during the startup of the EtherCAT automation network, the control bus subscriber may check the consistency of the target and actual configuration of the subordinate bus subscribers, wherein the actual configuration may be obtained, for example, by reading the identification object of the corresponding bus subscriber. As a rule, the product code and vendor ID must match. For the version number (revision number), the first data word, i.e., the Lo-Word (bits 0-15), must usually match, while for the second data word, i.e., the Hi-Word (bits s 16-31), a comparison may usually be carried out. The comparison may be carried out using comparison operators, for example. The Hi-Word (bits 16-31) should meet the condition that the Hi-Word in the actual configuration is larger than or equal to that in the target configuration (actual configuration>=target configuration), as this is incremented with each successive version of a product.

If the replacement bus subscriber were to replace the original bus subscriber in an existing bus configuration, this would result in the control bus subscriber detecting an incorrect identification during the initializing phase of the automation network, i.e., when the actual configuration of the automation network is recorded, and switching to an error state. The initializing phase could therefore not be completed successfully, and the replacement bus subscriber could not be activated in terms of its function.

One difficulty in this context is that the bus configuration is created at a point in time when it is still uncertain for which bus subscribers a replacement bus subscriber may be needed or used in the future. Consequently, a different product identifier and/or a different version number of the identification object of the replacement bus subscriber may also be unknown at this point in time.

### SUMMARY

The present invention provides an improved method for initializing an automation network and a corresponding automation network.

According to an aspect, a method initializes an automation network, wherein the automation network comprises a plurality of bus subscribers, having the steps of: providing a target configuration of the automation network, which contains identification objects assigned to the bus subscribers, determining an actual configuration of the automation network, wherein for each bus subscriber, the identification object associated with the bus subscriber in the target configuration is compared to an identification object read out from the bus subscriber, wherein, if a deviation exists between the identification objects, it is determined on the basis of a type identifier read out from the bus subscriber whether the bus subscriber is a replacement bus subscriber, wherein, if the type identifier indicates that the bus subscriber is a replacement bus subscriber, it is determined on the basis of a replacement list read out from the bus subscriber whether the original bus subscriber may be replaced by the replacement bus subscriber, triggering an error state and aborting the initialization if no permitted actual configuration is determined when determining the actual configuration.

According to another aspect, an automation network comprises a plurality of bus subscribers that are communicatively connected to one another via a bus system, wherein at least one bus subscriber of the plurality of bus subscribers is embodied as a replacement bus subscriber for replacing an original bus subscriber, wherein during an initializing phase of the automation network, a control bus subscriber checks the conformity of a target and an actual configuration of the bus subscribers by reading out identification objects of the bus subscribers, wherein for each bus subscriber, the identification object associated with the bus subscriber in the target configuration is compared to an identification object read out from the bus subscriber, wherein, if a deviation exists between the identification objects, it is determined on the basis of a type identifier read out from the bus subscriber whether the bus subscriber is a replacement bus subscriber, wherein, if the type identifier indicates that the bus subscriber is a replacement bus subscriber, it is determined on the basis of a replacement list read out from the bus subscriber whether the original bus subscriber may be replaced by the replacement bus subscriber, triggering an error state and aborting the initialization if no permitted actual configuration is determined when determining the actual configuration.

According to another aspect, a method initializes an automation network, wherein the automation network comprises a plurality of bus subscribers, having the steps of: providing a target configuration of the automation network, which contains identification objects assigned to the bus subscribers, determining an actual configuration of the automation network, wherein for each bus subscriber, the identification object associated with the bus subscriber in the target configuration is compared to an identification object read out from the bus subscriber, wherein, if a deviation exists between the identification objects, it is determined on the basis of a type identifier read out from the bus subscriber whether the bus subscriber is a replacement bus subscriber, wherein, if the type identifier indicates that the bus subscriber is a replacement bus subscriber, it is determined on the basis of a replacement list read out from the replacement bus subscriber whether the original bus subscriber may be replaced by the replacement bus subscriber, wherein the replacement list specifies which bus subscribers may be functionally replaced by a replacement bus subscriber, wherein, if the replacement list indicates that the replacement bus subscriber may replace the original bus subscriber, a replacement object that determines how the replacement bus subscriber is to function, in particular with regard to the functions of the original bus subscriber, is written into the replacement bus subscriber, and triggering an error state and aborting the initialization if no permitted actual configuration is determined when determining the actual configuration.

### EXAMPLES

A method for detecting a replacement bus subscriber in an automation network is proposed. At least one bus subscriber of the automation network is embodied as a replacement bus subscriber to replace an original bus subscriber. The method comprises the following steps:
providing a target configuration of the automation network in a first step, wherein the target configuration comprises a digital description of the automation network,
determining an actual configuration of the automation network for detecting a replacement bus subscriber by sending at least one data packet to the plurality of bus subscribers in a second step, wherein the actual configuration forms a real description of the automation network,
wherein determining the actual configuration in the second step is carried out based on the data packet by reading a first data field and/or a second data field and/or a third data field of an identification object and/or by reading a type identifier and/or by reading a replacement list of the plurality of bus subscribers,
wherein the identification object forms a first communication object comprising one or a plurality of data fields for identifying a bus subscriber,
wherein the type identifier indicates whether a bus subscriber is embodied as a replacement bus subscriber and wherein the type identifier comprises, in particular, a data field and/or a second communication object,
wherein the replacement list indicates which original bus subscribers may be replaced by a replacement bus subscriber, and
comparing the determined actual configuration with the target configuration based on the first and second steps in a third step for recognizing a replacement bus subscriber.

In addition, a method for configuring a replacement bus subscriber in an automation network is proposed, comprising the following steps:
providing a target configuration of an automation network in a first step, as well as a replacement bus subscriber that is embodied to replace at least one original bus subscriber,
wherein the target configuration comprises a digital description of the automation network with the plurality of bus subscribers, at least one bus subscriber of which is embodied as a replacement bus subscriber, and
writing a replacement object for setting a function, i.e. a mode of operation of the replacement bus subscriber in relation to the at least one original bus subscriber by sending a further data packet to the plurality of bus subscribers in a second step,
wherein the replacement object forms a third communication object comprising at least one data field, or
wherein the replacement object is embodied as an identification object that comprises a first communication object according to the above-mentioned or the following features with one or a plurality of data fields for identifying a bus subscriber.

Moreover, a bus subscriber for an automation network is proposed, which is embodied to carry out a method for recognizing a replacement bus subscriber according to the above-mentioned features and/or the following features and/or a method for configuring a replacement bus subscriber according to the above-mentioned and/or the following features. The bus subscriber is embodied in particular as a main device, i.e. as a control bus subscriber, for controlling and coordinating subordinate devices, i.e., subordinate bus subscribers.

Furthermore, a method for activating a function, i.e., an operating mode of a replacement bus subscriber in relation to an operating mode of at least one original bus subscriber in an automation network, as well as a replacement bus subscriber for replacing an original bus subscriber for an automation network, is proposed. The replacement bus subscriber is embodied to carry out the method described below for activating a function of the replacement bus subscriber. The method comprises the following steps:
receiving a replacement object in a first step,
wherein the replacement object forms a third communication object comprising at least one data field for setting the function of the replacement bus subscriber in relation to at least one original bus subscriber, or
wherein the replacement object is embodied as an identification object that forms a first communication object according to the above and/or the following characteristics, wherein the first communication object comprises one or a plurality of data fields for identifying a bus subscriber,
checking the support of the function of at least one original bus subscriber by the replacement bus subscriber in a second step,
wherein the checking of the support of the function of at least one original bus subscriber by the replacement bus subscriber is carried out, in particular taking into account the replacement object, and
activating the function of the replacement bus subscriber in accordance with the replacement object and/or in accordance with the identification object in a third step, provided that the checking in the second step has been carried out successfully.

Moreover, an automation network is proposed. The automation network comprises a plurality of bus subscribers that are communicatively connected to one another via a bus system. At least one bus subscriber of the plurality of bus subscribers is embodied as a replacement bus subscriber to replace an original bus subscriber according to the above-mentioned and/or the following features. At least one bus subscriber is embodied as a transmitter according to the above-mentioned features in order to recognize and/or configure a replacement bus subscriber based on one or a plurality of transmitted data packets. The automation network forms, in particular, an EtherCAT automation network, and the replacement bus subscriber is embodied as a subordinate device, i.e. a subordinate bus subscriber that may be controlled by a main device, i.e. a control bus subscriber. The bus subscriber embodied to recognize and/or to configure the replacement bus subscriber, i.e. the transmitter mentioned above, is embodied as a MainDevice for controlling and coordinating the SubordinateDevices. A replacement bus subscriber is embodied to carry out a method for activating a function. In this case, the replacement bus subscriber is embodied as a receiver.

It goes without saying that the aforementioned methods may be carried out by a computer or a similar unit, e.g., a processing unit, processor, etc.

### BRIEF DESCRIPTION OF THE DRAWINGS

The application is described in more detail with reference to the accompanying figures, in which:

FIG. 1 shows a schematic depiction of a method for detecting a replacement bus subscriber according to a first embodiment.

FIG. 2 shows a schematic depiction of a method for detecting a replacement bus subscriber according to a second embodiment.

FIG. 3 shows a schematic depiction of a method for configuring a replacement bus subscriber according to a first embodiment.

FIG. 4 shows a schematic depiction of a method for configuring a replacement bus subscriber according to a second embodiment.

FIG. 5 shows a schematic depiction of a method for configuring a replacement bus subscriber according to a third embodiment.

FIG. 6 shows a schematic depiction of a method for activating a function, i.e., a mode of operation of a replacement bus subscriber according to a first embodiment.

FIG. 7 shows a schematic depiction of a method for activating a function, i.e., a mode of operation, of a replacement bus subscriber according to a second embodiment.

FIG. 8 shows a schematic depiction of an automation network according to a first embodiment.

FIG. 9 shows a schematic depiction of an automation network according to a second embodiment.

FIG. 10 shows a schematic depiction of a replacement bus subscriber according to a first embodiment.

FIG. 11 shows a schematic depiction of a replacement bus subscriber according to a second embodiment.

FIG. 12 shows a schematic depiction of a replacement bus subscriber according to a third embodiment.

### DETAILED DESCRIPTION

The above-mentioned method for detecting a replacement bus subscriber provides a simple method for recording the actual configuration of an automation network and comparing it with a target configuration. Advantageously, the method may be carried out in a completely automated manner. Based on the aforementioned method, the replacement bus subscriber may advantageously be used to replace at least one original bus subscriber without the transmitter carrying out the aforementioned detection method, e.g., the control bus subscriber or main device detects an incorrect identification, e.g., during an initializing phase of the automation network, and, of course, without the target configuration being changed.

Based on the proposed methods and bus subscribers or automation network, not only may delivery problems with electronic components be easily solved or circumvented, but the method for detecting a replacement bus subscriber is also advantageous for replacing a defective original bus subscriber that would otherwise not be automatically detected during the initializing phase, for example. In the cases mentioned, the replacement bus subscriber may be easily used with new functionality. Products or bus subscribers may therefore be replaced without having to change the user's control program or reconfigure the automation network. This saves time, effort, and costs and avoids any errors during adjustment. Storage costs may also be reduced if a replacement bus subscriber is embodied to functionally replace a plurality of original bus subscribers, thus reducing the number of variants of original bus subscribers that need to be kept in stock. In addition, the downtime of the automation system's machine due to a mismatch between the actual and target configurations may be advantageously reduced.

A flexible combination of the method for recognizing a replacement bus subscriber, in which the reading out or, respectively, the reading of information is the focus, e.g., by reading the identification object, and the method for configuring a replacement bus subscriber, in which the focus is on writing information, e.g., writing the identification object or another communication object or the replacement object, are possible. It is conceivable that the identification object and the replacement object are the same first communication object. In addition, the methods may also be applied separately or only one of the methods mentioned may be applied. It is conceivable that the replacement bus subscriber is configured, but the method for recognizing the replacement bus subscriber is not performed beforehand by the control bus subscriber.

The bus subscriber that carries out the procedure for recognizing the replacement bus subscriber (reading) and the procedure for configuring it (writing) may form the transmitter, e.g. as a control bus subscriber or main device. The bus subscriber that carries out the procedure for activating a function, i.e. a replacement bus subscriber, may form the receiver.

The original bus subscriber may e.g. be an EL1002 input terminal of Beckhoff Automation (comprising a 2-channel digital input), while the replacement bus subscriber may e.g. be an EL8601-8411 multifunction terminal of Beckhoff Automation (12-channel multi-interface). If the replacement bus subscriber is a multifunction terminal, the replacement bus subscriber must be configured, because the multifunction terminal provides variable, i.e. adaptable, interfaces that may function as inputs (or alternatively as outputs) if required. This example is not to be understood as restrictive, since the original bus subscriber may alternatively also form an output terminal of type EL2002 of Beckhoff Automation (2-channel digital output) or a combined input and output terminal of type EL1259 of Beckhoff Automation (8-channel digital input and 8-channel digital output) or the above-mentioned multifunction terminal. Similarly, the replacement bus subscriber may form one of the above-mentioned terminals without restriction.

In a further embodiment, the target configuration as a digital description of the automation network comprises a description of a fieldbus topology of the automation system, in particular line, ring, tree, a sequence of bus subscribers connected to the fieldbus, configuration data of the bus subscribers, a table with identification objects of the bus subscribers. It goes without saying that the list is not exhaustive. For example, the digital description may be implemented as a digital description file.

In a further embodiment of the method for detecting a replacement bus subscriber, the first data field of the identification object is embodied as a product identifier of the bus subscriber, the second data field of the identification object is embodied as a version number of the bus subscriber, and the third data field is embodied as a manufacturer identifier of the bus subscriber. The version number comprises a first data word and a second data word. An original bus subscriber particularly comprises a first version from the product identifier and/or the version number, and a replacement bus subscriber particularly comprises a second version from the product identifier and/or the version number, in particular in the replacement list of the replacement bus subscriber. The second version from the product identifier and/or the version number differs in particular in the first data word of the version number and/or the product identifier from the first version.

Advantageously, a replacement bus subscriber may be easily recognized as such based on the second version from the product identifier and/or version number, in particular in the replacement list, and/or together with a type identifier, and an initializing phase of the automation network does not have to be terminated prematurely as a result.

In a further embodiment of the method for recognizing a replacement bus subscriber, at least the second data word of the version number of the identification object is comparable with the aid of a comparison operator. The second data word of the version number of the identification object of the replacement bus subscriber is, in particular, ascending in comparison to the second data word of the version number of the identification object of the original bus subscriber.

This allows for carrying out simple mathematical operations which facilitates the handling of the proposed method and provides good compatibility.

In a further embodiment of the method for detecting a replacement bus subscriber, after reading the first data field and/or the second data field and/or the third data field of the identification object, a comparison with the target configuration is carried out in a first intermediate step. If the comparison in the first intermediate step reveals that there is a deviation between the determined actual configuration and the target configuration, the type identification of a bus subscriber is read in a second intermediate step. If the type identification of the bus subscriber in the second intermediate step indicates that the bus subscriber is embodied as a replacement bus subscriber, the replacement list of the replacement bus subscriber is read in a third intermediate step and compared with the target configuration.

The order of the steps mentioned in the procedure may be varied as desired so that the procedure offers maximum flexibility. The individual steps may be carried out successively. The best possible transparency and traceability may be achieved by carrying out a comparison between the target and actual configurations during each intermediate step. In this way, an error message may be generated at an early stage, or the initializing phase may be terminated.

In a further embodiment of the method for detecting a replacement bus subscriber, the reading of the first data field and/or the second data field and/or the third data field of the identification object and/or the type identifier and/or the replacement list in the second step may be carried out based on a first transmitted data packet. The reading of the type identifier in the second intermediate step may be carried out based on a second transmitted data packet, and the reading of the replacement list in the third intermediate step may be carried out based on a third transmitted data packet.

This offers the advantage of a clear division of the readout or reading steps carried out, greater clarity, and less susceptibility to errors compared to reading out all information in a single readout step/based on a single data packet.

In a further embodiment of the method for detecting a replacement bus subscriber, an error message may be generated in a fourth intermediate step if the comparison of the recorded actual configuration based on the type identification in the second intermediate step and/or the comparison of the recorded actual configuration based on the replacement list in the third intermediate step with the target configuration includes a deviation from the target configuration. This offers the advantage of allowing for terminating the method in a defined manner.

In a further embodiment of the method for detecting a replacement bus subscriber, the aforementioned method is carried out during an initializing phase of the automation network. The initializing phase may be terminated by generating the error message in the fourth intermediate step. This offers the advantage of allowing the process to be terminated in a defined manner.

In a further embodiment of the method for configuring a replacement bus subscriber in an automation network, providing the target configuration in the first step includes sending the target configuration with the aid of a fourth data packet to the plurality of bus subscribers of the automation network.

In this way, the individual bus subscribers may check for themselves whether the actual configuration matches the target configuration. An application is conceivable in particular if no prior detection of the bus subscribers has taken place, i.e., if the method for detecting a replacement bus subscriber has not been carried out beforehand.

In a further embodiment of the method for configuring a replacement bus subscriber, before writing the replacement object in the second step, a method for detecting a replacement bus subscriber in an automation network may be carried out according to one of the above-mentioned features in order to determine an actual configuration of the automation network.

This provides the advantage of allowing for improved compatibility and instant configuration of the replacement bus subscriber (writing), since a replacement bus subscriber has already been recognized as such by the method for recognizing a replacement bus subscriber. In addition, this procedure ensures that only one replacement bus subscriber is actually configured.

In a further embodiment of the method for configuring a replacement bus subscriber, if the replacement object has been written to a bus subscriber that is not embodied as a replacement bus subscriber, the configuration of the function of this bus subscriber remains unchanged.

This provides the advantage of additional security so that a configuration affects only one replacement bus subscriber and no other bus subscribers.

In a further embodiment of the method for configuring a replacement bus subscriber, the replacement bus subscriber is embodied, provided that the replacement object has been written in the second step and no method for recognizing a replacement bus subscriber according to the above-mentioned features has been carried out, in a third step to carry out a check of the support of the function of at least one original bus subscriber, in particular taking into account the replacement object, and to transmit a confirmation of the configuration of the function of the replacement bus subscriber, i.e., a mode of operation of the replacement bus subscriber in relation to a mode of operation of at least one original bus subscriber, in a fourth step, provided that the check of the replacement object in the third step was successful.

This advantageously reduces network traffic, as the replacement bus subscriber may check for the presence of a replacement bus subscriber itself. Consequently, the individual steps (reading) for detecting this or the readout step may be omitted.

In a further embodiment of the method for activating a function, i.e., an operating mode of a replacement bus subscriber, the aforementioned method comprises a fourth step sending a confirmation of the activation of the function of the replacement bus subscriber, provided that the third step has been successfully carried out.

This provides the advantage of ensuring that the replacement bus subscriber has activated the desired function and, as such, may be used to its full extent (within the scope of its function) in the automation network.

In a further embodiment, the replacement bus subscriber comprises at least one communication unit that is communicatively connected to at least one memory unit of the replacement bus subscriber. The memory unit comprises, in particular, a non-volatile memory. The communication unit is communicatively connected to a bus system.

This advantageously allows for a simple design of the replacement bus subscriber as well as cost-effective implementation and good compatibility with known standards and systems.

In a further embodiment, the replacement bus subscriber also comprises a microcontroller unit that is communicatively connected to the communication unit for checking the replacement object and/or the identification object. The replacement bus subscriber comprises an object directory, wherein the identification object and/or the replacement object may be stored in the object directory.

The microcontroller unit may be embodied as a microcontroller (uC for short) and advantageously carry out the checking of the replacement object and/or the identification object. This represents the preferred design of the replacement bus subscriber.

In a further embodiment, the replacement bus subscriber is embodied as a subordinate device, i.e., as a subordinate bus subscriber that may be controlled by a main device, i.e., a control bus subscriber. If the replacement bus subscriber is embodied as a subordinate device, the communication unit is embodied as an EtherCAT subdevice controller.

This provides the advantage of allowing for the use of the well-known EtherCAT standard. In addition, this allows for clear hierarchical structures of the individual bus subscribers, wherein the SubordinateDevice may, e.g., be embodied as the above-mentioned receiver and the MainDevice, for example, as the above-mentioned transmitter.

It is to be noted that the figures are schematic in nature and not to scale. In this sense, components and elements shown in the figures may be exaggeratedly large or small for better understanding. Furthermore, please note that the reference symbols in the figures have been chosen to remain unchanged or similar if they refer to identical or similar elements and/or components.

The term “MainDevice” (abbreviated “MDevice”) refers to a “control bus subscriber” that is embodied to control and coordinate “SubordinateDevices” in the automation network. In automation systems, a programmable logic controller (PLC) typically carries out cyclical control processes to generate output data for subordinate bus subscribers and/or other subordinate bus subscribers based on input data from subordinate bus subscribers, which is sent by the “MainDevice” or control bus subscriber. The PLC uses control software for this purpose, e.g., TwinCAT of Beckhoff Automation. A “MainDevice” is a software module independent of the control software that takes over the control and coordination of the subordinate bus subscribers. The terms “MainDevice” and “control bus subscriber” may be understood as synonyms.

The term “subordinate device” (or “subdevice” for short) refers to a subordinate bus subscriber that may be controlled by a “main device,” i.e., a “control bus subscriber,” wherein “controllable” also includes “configurable.” A “SubDevice” is therefore a subordinate unit in a system or machine that may be controlled by the main device, i.e., the “MainDevice”. The “SubDevice” processes the data packets sent by the “MainDevice”, e.g., Ethernet data packets, carries out the tasks specified in the data packet, and forwards the data packet. “SubDevices” may form, for example, “original bus subscribers” and “replacement bus subscribers.” A “SubDevice” may, for example, form a terminal with an ASIC chip or a programmable FPGA as an EtherCAT Subdevice Controller (ESC) as a processing unit. Each EtherCAT subdevice includes such a processing unit embodied as an ESC so that cyclic and acyclic process data may be exchanged between the main device and the subdevice via the EtherCAT field bus.

An “original bus subscriber” refers to a bus subscriber that is included in the original “target configuration” of the automation network.

A “replacement bus subscriber” is embodied to functionally replace at least one “original bus subscriber”, i.e., in terms of the mode of operation of an “original bus subscriber” and/or a new functionality that the “original bus subscriber” to be replaced does not include, for example.

A “target configuration” of the automation network comprises a digital description of the automation network comprising the plurality of bus subscribers, i.e., a digital description of the fieldbus topology of the automation network: line, ring, tree, etc., the sequence of bus subscribers connected to the fieldbus, the configuration data of the bus subscribers, a table with identification objects of the bus subscribers, etc. The digital description may be implemented, for example, as a digital description file or similar.

An “actual configuration” of the automation network forms a starting point, i.e., a real description of the automation network, meaning a real description of the field-bus topology and the bus subscribers physically connected to the field bus. The actual configuration may be recorded, for example, by reading out or extracting information from the individual bus subscribers. Alternatively, for field-bus systems in which the bus subscribers are not actively recorded, the individual bus subscribers may read the information received (e.g., a received “target configuration”) to determine the “actual configuration”, compare it with their own information, and, as the case may be, transmit a short confirmation via the field bus upon detection of a “replacement bus subscriber” and successfully activating its function, they may transmit a short confirmation via the field bus so that cyclical control processes of the automation system may be carried out based on this, including with the “replacement bus subscriber”.

An “identification object” is a communication object, i.e., a digital description file of a product or bus subscriber, e.g. in EtherCAT systems and EtherCAT bus subscribers, an esi file, i.e. an EtherCAT SubordinateDevice Information file. The identification object comprises a plurality of data fields for identifying a bus subscriber. The data fields of the “identification object” may be read to determine the “actual configuration” of the automation network. The “identification object” of a “replacement bus subscriber” may differ from the “identification object” of an “original bus subscriber”, for example. The data fields of the “identification object” may be written, for example, in the case of detection of a “replacement bus subscriber” based on reading the “identification object” and/or reading a “type identifier” and/or reading a “replacement list” in order to set the function of the “replacement bus subscriber”.

A “communication object” forms a data structure comprising a collection of data that is made available in the automation network, e.g. access rights of the individual bus subscribers, or the like.

A “product identifier” forms a device- or bus subscriber-specific identifier or code that is embodied differently for different devices or for different bus subscribers, e.g., terminals, each of which comprises an ASIC chip (input, output, multifunction terminals, or similar).

A “manufacturer identifier” is a manufacturer-dependent identifier or code that may be embodied differently depending on the manufacturer of the device or bus subscriber.

A “version number” distinguishes between individual versions of the same device or bus subscriber in order to clearly identify their further developments.

A “replacement object” may form a further separate communication object for the “identification object” that comprises at least one data field that is written to set the function of the “replacement bus subscriber.” The replacement object may form a separate digital file for writing or configuration. Alternatively, the “replacement object” may also correspond to the “identification object”, i.e., form the same communication object. The “replacement object”, or the “identification object” as the same communication object as the “replacement object”, specifies how the replacement bus subscriber should behave functionally, i.e., in terms of its mode of operation. The replacement object may comprise the above-mentioned target configuration of the automation network, i.e. it may comprise the identification object of at least one original bus subscriber that the replacement bus subscriber may functionally replace.

A “type identifier” specifies whether a bus subscriber is embodied as a “replacement bus subscriber” or not. For example, a “type identifier” may comprise a data field that was previously unused and assigned the value zero and now comprises a value that indicates the presence of a “replacement bus subscriber”. As an alternative or in addition, the “type identifier” may comprise a first further communication object which indicates with the aid of the first further communication object that an “replacement bus subscriber” is present (an original bus subscriber would, for example, not comprise the first further communication object or, alternatively, comprise it unused with the value zero).

A “replacement list” specifies which “original bus subscribers” may be functionally replaced by a “replacement bus subscriber”.

A “data word” is a specific amount of data that a computer may process in one step in an arithmetic logic unit of a processing unit, e.g. a processor.

An “initializing phase” specifies a ramp-up or start-up phase of an automation network. In the “initializing phase”, various data packets are exchanged in order to read out the properties of the bus subscribers or to identify the bus subscribers.

“Control process” refers to the general, cyclically performed control operation of the automation network.

The proposed methods for detecting and configuring a replacement bus subscriber, as well as the proposed method for activating a function of a replacement bus subscriber and the individual bus subscribers of the automation network that are embodied to carry out the methods, offer a way to replace bus subscribers in an automation network without having to change a user's control program. A replacement bus subscriber that is intended to functionally replace at least one original bus subscriber may be automatically detected and configured to carry out the corresponding function. The replacement bus subscriber may also automatically activate its function and be used to its full extent for cyclic control processes. This may also significantly simplify the maintenance of complex automation networks.

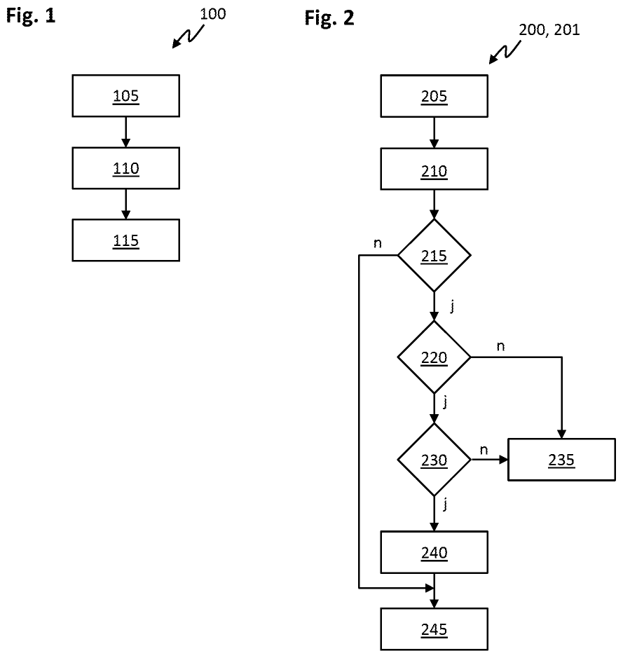

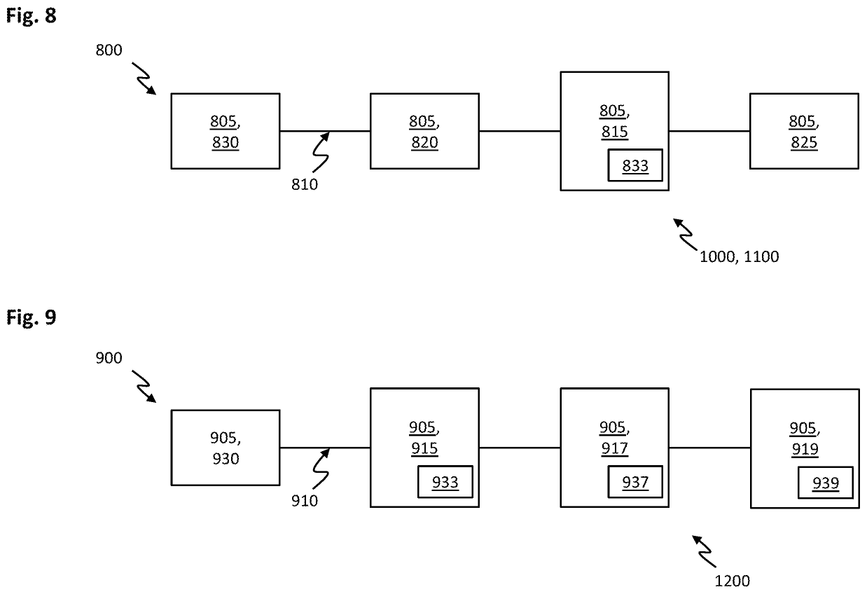

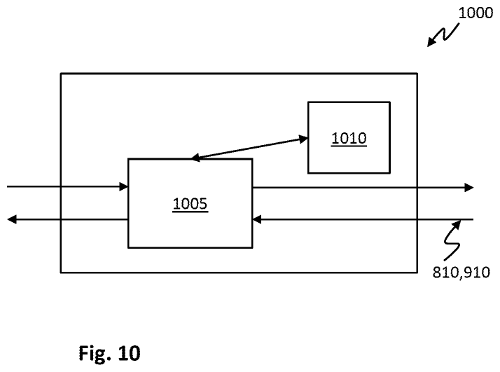

FIGS. 1, 2, 8, and 9 are described together in the following. However, it goes without saying that the following description is not limited exclusively to the figures mentioned, but that the features described may also be applied in combination with the further figures. FIG. 1 shows a schematic depiction of a method 100 for detecting a replacement bus subscriber 815, 915, 917, 919, 1000, 1100, 1200 according to a first embodiment, and FIG. 2 shows a schematic depiction of a method 200 for detecting a replacement bus subscriber 815, 915, 917, 919, 1000, 1100, 1200 according to a second embodiment. FIG. 8 shows a schematic depiction of an automation network 800 according to a first embodiment, and FIG. 9 shows a schematic depiction of an automation network 900 according to a second embodiment.

FIGS. 8 and 9 each show different embodiments of automation networks 800, 900, each of which comprises a plurality of bus subscribers 805, 905. The plurality of bus subscribers 805, 905 are each communicatively connected to one another via a bus system 810, 910 (a field-bus system). At least one bus subscriber of the plurality of bus subscribers 805, 905 is configured in both automation networks 800, 900 as a replacement bus subscriber 815, 915, 917, 919 to replace an original bus subscriber. For example, the automation network 800 in FIG. 8 comprises a first and second original bus subscriber 820, 825, as well as a replacement bus subscriber 815, while the automation network 900 in FIG. 9 comprises, for example, a first to third replacement bus subscriber 915, 917, 919. It goes without saying that the two views of automation networks 800 and 900 each show the replacement of original bus subscribers that has already been carried out; i.e., FIG. 8 shows the replacement of an original bus subscriber by the replacement bus subscriber 815, and FIG. 9 shows the replacement of the first to third original bus subscribers. The automation network 900 in FIG. 9 particularly shows that a replacement bus subscriber may functionally replace a plurality of original bus subscribers, which will be described in more detail below. This may have the advantage for the user of only having to manage one type of bus subscriber.

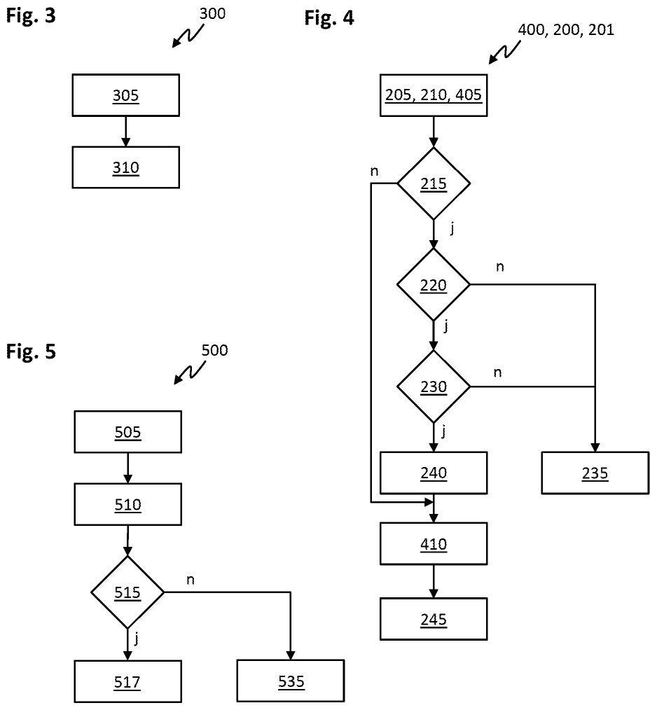

At least one bus subscriber 830, 930 of the automation networks 800, 900 is embodied to recognize and/or configure a replacement bus subscriber 815, 915, 917, 919, 1000, 1100, 1200. The aforementioned bus subscriber 830, 930 is embodied to execute a method 100, 200 for recognizing a replacement bus subscriber 815, 915, 917, 919, 1000, 1100, 1200, which will be described in the following, and/or a method for configuring 300, 400, 500 a replacement bus subscriber 815, 915, 917, 919, 1000, 1100, 1200, which will be described in the following with reference to FIGS. 3 to 5. The aforementioned bus subscriber 830, 930 may, for example, be embodied as a main device, i.e., as a control bus subscriber, for controlling and coordinating subordinate devices, i.e., subordinate bus subscribers, which may form a replacement for the bus subscribers 815, 915, 917, 919, 1000, 1100, 1200. However, it goes without saying that the aforementioned methods 100, 200, 300, 400, 500 are not limited to a control bus subscriber subordinate to a bus subscriber of an automation network.

Preferably, the automation networks 800, 900 in FIGS. 8 and 9 each form an EtherCAT automation network, and a replacement bus subscriber 815, 915, 917, 919, 1000, 1100, 1200 is each embodied as a subordinate device, i.e. as a subordinate bus subscriber that may be controlled by the main device, i.e. the control bus subscriber 830, 930. The bus subscriber 830, 930, which is embodied to recognize and/or configure the replacement bus subscriber 815, 915, 917, 919, 1000, 1100, 1200 is embodied as a MainDevice for controlling and coordinating the SubordinateDevices.

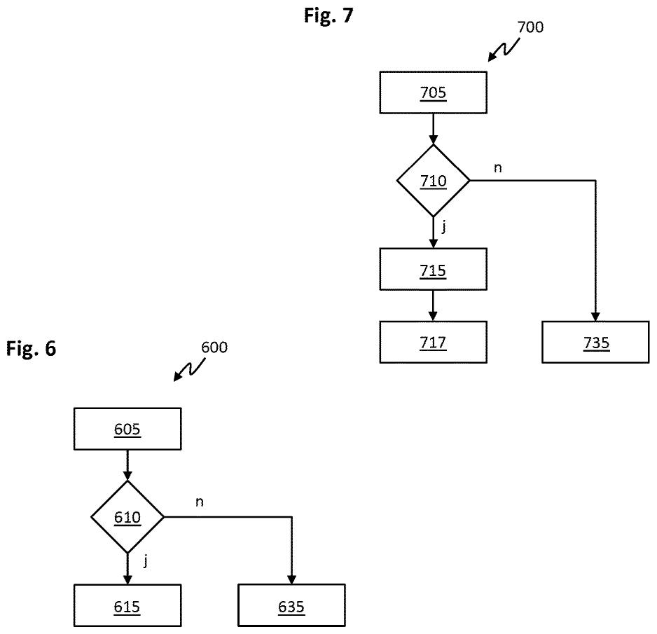

A replacement bus subscriber 815, 915, 917, 919, 1000, 1100, 1200 is respectively embodied to carry out a method for activating a function 600, 700 of the replacement bus subscriber 815, 915, 917, 919, 1000, 1100, 1200, wherein the method for activating the function 600, 700 will be described with reference to FIGS. 6 and 7.

The above-mentioned method 100 according to the first embodiment in FIG. 1 for detecting a replacement bus subscriber 815, 915, 917, 919, 1000, 1100, 1200 in an automation network 800, 900, which is embodied, for example, according to FIGS. 8 and 9, comprises, for example, in a first step 105, the provision a target configuration of the automation network 800, 900. The target configuration comprises a digital description of the automation network 800, 900 with the plurality of bus subscribers 805, 905. As a digital description of the automation network, the target configuration comprises a description of a field-bus topology of the automation system, e.g., line, ring, tree, a sequence of bus subscribers connected to the field bus, configuration data of the bus subscribers, a table with identification objects of the bus subscribers, etc. It goes without saying that the list is not exhaustive. For example, the digital description may be implemented as a digital description file.

A second step 110 of the method 100 comprises determining an actual configuration of the automation network 800, 900 for detecting a replacement bus subscriber 815, 915, 917, 919, 1000, 1100, 1200 by sending at least one data packet to the plurality of bus subscribers 805, 905, wherein the actual configuration forms a real description of the automation network 800, 900. The actual configuration of the automation network 800, 900 forms an initial situation, i.e., a real description of, for example, the field-bus topology and the bus subscribers physically connected to the field bus, etc.

In this context, the actual configuration is determined in the second step 110 based on at least one data packet by reading a first data field and/or a second data field and/or a third data field of an identification object and/or by reading a type identifier and/or by reading a replacement list 833, 933, 937, 939 of the plurality of bus subscribers 805, 905.

The identification object forms a first communication object that comprises one or a plurality of data fields for identifying a bus subscriber. The first data field of the identification object is embodied as a product identifier of the bus subscriber, the second data field of the identification object is embodied as a version number of the bus subscriber, and the third data field is embodied as a manufacturer identifier of the bus subscriber. The version number comprises a first data word and a second data word. An original bus subscriber, e.g., comprises a first version from the product identifier and/or the version number, while a replacement bus subscriber 815, 915, 917, 919, 1000, 1100, 1200 e.g. comprises a second version from the product identifier and/or the version number. The second version from the product identifier and/or version number may differ from the first version, for example, in the first data word of the version number and/or product identifier. It goes without saying that the information referred to may be read by the control bus subscriber 830, 930, which sends the data packet for reading the information of the bus subscribers and thus forms the transmitter.

The first data word of the version number e.g. forms the Lo-Word (bits 0-15). The second data word of the version number of the identification object is comparable, for example, with the aid of a comparison operator, provided that the second data word of the version number of the identification object of the replacement bus subscriber 815, 915, 917, 919, 1000, 1100, 1200, for example, is ascending in comparison to the second data word of the version number of the identification object of the original bus subscriber. The second data word forms the Hi-Word (bits 16-31). The comparison may e.g. be carried out by using greater than or equal to (>=) comparison operators, wherein the comparison is based on the second data word of the version number of the identification object of the original bus subscriber with the second data word of the version number from the replacement list 833, 933, 937, 939 of the replacement bus subscriber 815, 915, 917, 919, 1000, 1100, 1200. This is done on the condition that the manufacturer ID, product ID, and the first data word of the version number of the replacement bus subscriber 815, 915, 917, 919, 1000, 1100, 1200 match the corresponding values from the identification object of the original bus subscriber.

An original bus subscriber may be indicated, for example, as EL1002-0000-0016, wherein “EL1002” is the product identifier, “0000” is the first data word of the version number, and “0016” is the second data word of the version number of the original bus subscriber. The target configuration of the automation network 800, 900, comprising, for example, only the aforementioned bus subscriber, would then form EL1002-0000-0016. The replacement list 833, 933, 937, 939 of a replacement bus subscriber 815, 915, 917, 919, 1000, 1100, 1200 may e.g. contain EL1002-0000-0019. EL1002-0000-0019 would therefore form the actual configuration of the automation network 800, 900 in the example. The second data word of the version number of the replacement bus subscriber 815, 915, 917, 919, 1000, 1100, 1200 is formed with “0019” in ascending order in comparison to the second data word of the version number of the identification object of the original bus subscriber with “0016”. The replacement bus subscriber 815, 915, 917, 919, 1000, 1100, 1200 with the aforementioned replacement list 833, 933, 937, 939, comprising EL1002-0000-0019, may therefore replace the original bus subscriber with “0016” as the second data word of the version number of the original bus subscriber, since 19>=16. The type identifier specifies whether a bus subscriber is embodied as a replacement bus subscriber 815, 915, 917, 919, 1000, 1100, 1200 and comprises, for example, a data field and/or a second communication object for this purpose.

The replacement list 833, 933, 937, 939 indicates which original bus subscribers may be functionally replaced by a replacement bus subscriber 815, 915, 917, 919, 1000, 1100, 1200. For this purpose, the replacement list 833, 933, 937, 939 comprises the product identifier of the original bus subscriber to be replaced and at least the first data word of the version number (low word). The replacement list 833, 933, 937, 939 may also include the second data word of the version number (high word) in accordance with the above example in order to carry out the comparison described above using a comparison operator. For example, the replacement list 833 of the replacement bus subscriber 815 in FIG. 8 includes the product identifier PC2 and the first data word of the version number RL2.

It goes without saying that the product identifier PC2 and the first data word of the version number RL2 of the replacement list 833 of the replacement bus subscriber 815 have been chosen merely as examples to illustrate the principle. Specific values for the product identifier and the first data word of the version number of the replacement bus subscriber 815 in FIG. 8 may be chosen similarly to the above example. It also goes without saying that this applies not only to the content of replacement list 833 of replacement bus subscriber 815 in FIG. 8, but is also transferable to a first to third replacement bus subscriber 915, 917, 919 with a first to third replacement list 933, 937, 939 in FIG. 9. Furthermore, it goes without saying that the representative principle of clarification applies at least to the replacement bus subscriber's own product identifier and its own first data word of the version number in FIG. 8, as well as to the first to third replacement bus subscribers 915, 917, 919 in FIG. 9. Specific values for at least the own product identifier and the own first data word of the version number may be selected similarly to the above example for the replacement bus subscriber 815 in FIG. 8 and for the first to third replacement bus subscribers 915, 917, 919 in FIG. 9.

The own product identifier of the replacement bus subscriber 815, 1000, 1100 in FIG. 8 may be, for example, PC20, and the own first data word of the version number of the replacement bus subscriber 815, 1000, 1100 in FIG. 8 may be RL20. The product identifier of the first original bus subscriber 820 may, e.g., be PC1, and the first data word of the version number of the first original bus subscriber 820 may, e.g., be RL1. The product identifier of the second original bus subscriber 825 may, e.g., be PC3, and the first data word of the version number of the second original bus subscriber 825 may be, for example, RL3.

Similarly, the product identifier of the first replacement bus subscriber 915 in FIG. 9 may be PC20, and the first data word of the version number of the first replacement bus subscriber 915 in FIG. 9 may be RL20. The replacement list 933 of the first replacement bus subscriber 915 in FIG. 9 may e.g., have the product identifier PC1 with the associated first data word of the version number RL1, as well as the product identifier PC2 with the associated first data word of the version number RL2, and the product identifier PC3 with the associated first data word of the version number RL3.

The own product identifier of the second replacement bus subscriber 917 in FIG. 9 may e.g. be PC20, and the own first data word of the version number of the second replacement bus subscriber 917 in FIG. 9 may be RL20. The replacement list 937 of the second replacement bus subscriber 917 in FIG. 9 may e.g. have the product identifier PC1 with the associated first data word of the version number RL1, as well as the product identifier PC2 with the associated first data word of the version number RL2 and the product identifier PC3 with the associated first data word of the version number RL3.

The own product identifier of the third replacement bus subscriber 919 in FIG. 9 may e.g. be PC20, and the own first data word of the version number of the third replacement bus subscriber 919 in FIG. 9 may be RL20. The replacement list 939 of the third replacement bus subscriber 919 in FIG. 9 may, e.g., have the product identifier PC1 with the associated first data word of the version number RL1, as well as the product identifier PC2 with the associated first data word of the version number RL2 and the product identifier PC3 with the associated first data word of the version number RL3.

As mentioned above, it goes without saying that the values specified for the product identifier and the first data word of the version number are only examples and may be implemented differently. Alternatively, the manufacturer identifier may also be taken into account. In the examples given, the manufacturer identifier for the original bus subscriber and the replacement bus subscribers 815, 915, 917, 919, 1000, 1100, 1200 have been chosen to be identical and are therefore not explicitly described. It goes without saying here that the manufacturer ID may vary between the original bus subscribers and the replacement bus subscribers 815, 915, 917, 919, 1000, 1100, 1200 if the embodiment differs.

A third step 115 of the method 100 comprises comparing the determined actual configuration with the target configuration based on the first and second steps 105, 110 for recognizing the replacement bus subscriber 815, 915, 917, 919, 1000, 1100, 1200. In FIG. 8, when the control bus subscriber 830 reads the identification object of the replacement bus subscriber 815, a deviation between the target and actual configurations would be detected, i.e., its own product identifier PC20 instead of PC2 of the original bus subscriber and its own first data word of the version number RL20 instead of RL2 of the original bus subscriber. In conventional automation systems, an error message would then be generated. However, since method 100 includes the ability to read out further information, such as the type information and the replacement list 833, in the example mentioned, when reading the type information and/or the replacement list, it could be determined that the bus subscriber is in fact a replacement bus subscriber 815 which, for example, according to replacement list 833, is embodied to functionally replace the previously connected original bus subscriber with the product identifier PC2 and the first data word of the version number RL2.

The original bus subscriber mentioned may e.g., be an input terminal of type EL1002 of Beckhoff Automation (comprising a 2-channel digital input), while the replacement bus subscriber 815 in FIG. 8 may, for example, be a multifunction terminal of type EL8601-8411 of Beckhoff Automation (12-channel multi-interface). The replacement bus subscriber 815 therefore comprises inputs and outputs as a multifunction terminal. The replacement bus subscriber 815, embodied as a multifunction terminal, is therefore suitable for replacing the original bus subscriber embodied as an input terminal when its comprehensive interfaces are configured accordingly, e.g., 2 digital inputs.

This example is not to be understood as restrictive, since the original bus subscriber may alternatively also form an output terminal of type EL2002 of Beckhoff Automation (2-channel digital output) or a combined input and output terminal of type EL1259 of Beckhoff Automation (8-channel digital input and 8-channel digital output) or the above-mentioned multifunction terminal. Similarly, the replacement bus subscriber 815 may then form an alternative to the above-mentioned terminals without restriction, provided that it is functionally suitable for replacing the alternatively embodied original bus subscriber.

The method 100 is therefore suitable for fieldbus systems in which, for example, a control bus subscriber actively reads out the identification of, for example, subordinate bus subscribers, i.e., an actual configuration of the automation network is recorded.

The method for detecting a replacement bus subscriber 815, 915, 917, 919, 1000, 1100, 1200 according to a second embodiment 200 in FIG. 2 may be embodied in a first step 205 and a second step 210 in a similar manner to the method for detecting a replacement bus subscriber 815, 915, 917, 919, 1000, 1100, 1200 according to the first embodiment 100 in FIG. 1, namely that the first step 205 of the method for detecting a replacement bus subscriber 815, 915, 917, 919, 1000, 1100, 1200 according to the second embodiment 200 comprises, for example, providing the target configuration. The second step 210 of the method for detecting a replacement bus subscriber 815, 915, 917, 919, 1000, 1200 according to the second embodiment 200 comprises, for example, determining the actual configuration by reading the first data field (product identifier) and/or the second data field (version number) and/or the third data field (manufacturer identifier) of the identification object, for example the replacement bus subscriber 815 in FIG. 8 as mentioned above.

To avoid repetition, reference is therefore made to the above description. Reading the first data field and/or the second data field and/or the third data field of the identification object in the second step 210 of the method for detecting a replacement bus subscriber 815, 915, 917, 919, 1000, 1100, 1200 according to the second embodiment 200 may be carried out, for example, based on a first transmitted data packet, similar to determining the actual configuration in the second step 110 of the detection method according to the first embodiment 100 in FIG. 1. In FIG. 1, all information may be read out with the first data packet in the second step 110, while in the second step 210 in FIG. 2, for example, only the identification object is read out with the first data packet. It goes without saying that this does not constitute a limitation and may also be implemented alternatively.

After reading the first data field (product identifier) and/or the second data field (version number) and/or the third data field (manufacturer identifier) of the identification object in the second step 210, in a first intermediate step 215 of the method for detecting a replacement bus subscriber 815, 915, 917, 919, 1000, 1100, 1200 according to the second embodiment 200 in FIG. 2, the comparison with the target configuration is carried out. This may be done as described above, wherein the first intermediate step 215 of the method for detecting a replacement bus subscriber 815, 915, 917, 919, 1000, 1100, 1200 according to the second embodiment 200 may form a branch. If the comparison in the first intermediate step 215 of the method for detecting a replacement bus subscriber 815, 915, 917, 919, 1000, 1100, 1200 according to the second embodiment 200 reveals that there is a deviation between the determined actual configuration and the target configuration (j-branch), the type identifier of the bus subscriber is read in a second intermediate step 220. The reading of the type identifier in the second intermediate step 220 may e.g. be carried out based on a second data packet sent. The second intermediate step 220 may form a further branch.

If the type identifier of the bus subscriber in the second intermediate step 220 indicates that the bus subscriber is configured as a replacement bus subscriber 815, 915, 917, 919, 1000, 1100, 1200 (j-branch of the second intermediate step 220), the replacement list 833, 933, 937, 939 of the replacement bus subscriber 815, 915, 917, 919, 1000, 1100, 1200 is read in a third intermediate step 230 and compared with the target configuration. This may also be done in accordance with the example described above. The third intermediate step 230 may also form a branch. Reading the replacement list 833, 933, 937, 939 in the third intermediate step 230 may be performed, for example, based on a third data packet sent.

If the third intermediate step 230 of the method according to the second embodiment 200 results in a match between the replacement list and the target configuration (j-branch of the third intermediate step 230), a third step 240 of the method according to the second embodiment 200 may be carried out. The third step 240 of the method according to the second embodiment 200 may, for example, comprise recognizing the corresponding bus subscriber, e.g, as replacement bus subscriber 815. A fourth step 245 of the method according to the second embodiment 200 may, for example, comprise continuing the method for recognizing a replacement bus subscriber according to the second embodiment 200 for the next bus subscriber physically connected to the bus system 810, e.g., the second original bus subscriber 825.

If comparing the recorded actual configuration based on the identification object in the first intermediate step 215 of the method according to the second embodiment 200 with the target configuration does not reveal any deviation from the target configuration (n-branch), the fourth step 245 may be carried out, i.e. the method for detecting a replacement bus subscriber according to the second embodiment 200 may be carried out for the next bus subscriber physically connected to the bus system 810. If the type identification of the bus subscriber in the second intermediate step 220 indicates that the bus subscriber is not configured as a replacement bus subscriber 815, 915, 917, 919, 1000, 1100, 1200 (n-branch of the second intermediate step 220), an error message may be generated in the fourth intermediate step 235. If the third intermediate step 230 of the method according to the second embodiment 200 results in a deviation of the replacement list from the target configuration (n-branch of the third intermediate step 230), an error message may be generated in the fourth intermediate step 235. The fourth intermediate step 235 may therefore correspond to the n branch of the second intermediate step 220 and the third intermediate step 230.

It goes without saying that the reading of the aforementioned information, i.e. the sending of the individual data packets, may be carried out by the control bus subscriber 830, 930. The fourth intermediate step 235 may also be carried out by the control bus subscriber 830, 930 and, for example, the initializing phase 201 may be terminated with an error message. Similarly, the third step 240 of the method according to the second embodiment 200 may be carried out by the corresponding control bus subscriber 830, 930.

It goes without saying that the above description also applies to the following figures and vice versa. FIGS. 3 to 5 are described in combination in the following. FIG. 3 shows a schematic depiction of a method 300 for configuring a replacement bus subscriber 815, 915, 917, 919, 1000, 1100, 1200 according to a first embodiment. FIG. 4 shows a schematic depiction of a method 400 for configuring a replacement bus subscriber 815, 915, 917, 919, 1000, 1100, 1200 according to a second embodiment, and FIG. 5 shows a schematic depiction of a method 500 for configuring a replacement bus subscriber 815, 915, 917, 919, 1000, 1100, 1200 according to a third embodiment.

The aforementioned methods for configuration according to the first to third embodiments 300, 400, 500 in FIGS. 3 to 5 may be carried out independently of the methods for detection of a replacement bus subscriber 815, 915, 917, 919, 1000, 1100, 1200 according to the first and second embodiments 100, 200 in FIGS. 1 and 2. This is because field-bus systems in automation technology are typically divided up into systems in which, for example, a control bus subscriber actively reads out an identification of the subordinate bus subscribers, i.e. the actual configuration of the automation network is recorded, and into systems in which, for example, the subordinate bus subscribers independently check an identification and, as the case may be, transmit a confirmation to the control bus subscriber. In the latter case, the control bus subscriber does not actively read out any identification of the subordinate bus subscribers. The method for configuring a replacement bus subscriber according to the first to third embodiments 300, 400, 500 is therefore independently applicable. In the first case, the method for detecting a replacement bus subscriber 815, 915, 917, 919, 1000, 1100, 1200 according to the first and second embodiments 100, 200 may also be combined with the method for configuring it according to the first to third embodiments 300, 400, 500 and, for example, be carried out beforehand.

The method for configuring a replacement bus subscriber 815, 915, 917, 919, 1000, 1100, 1200 according to the first embodiment 300 in FIG. 3 in an automation network 800, 900 according to FIGS. 8, 9 comprises, in a first step 305, providing a target configuration of the automation network 800, 900 (as mentioned above). Furthermore, the first step 305 of the configuration method according to the first embodiment 300 may comprise providing a replacement bus subscriber 815, 915, 917, 919, 1000, 1100, 1200. If the method for detecting a replacement bus subscriber 815, 915, 917, 919, 1000, 1100, 1200 according to the first and second embodiments 100, 200 preceded the configuration method according to the first embodiment 300 in terms of execution time, the target configuration may e.g. have already been provided to the control bus subscriber 830, 930 and/or the plurality of bus subscribers 805, 905. The corresponding replacement bus subscriber 815, 915, 917, 919, 1000, 1100, 1200 may also have been identified as such and thus provided. In the event that the aforementioned method for detecting a replacement bus subscriber 815, 915, 917, 919, 1000, 1100, 1200 according to the first and second embodiments 100, 200 has not been performed beforehand, the target configuration may e.g. be provided to the control bus subscriber 830, 930 and/or to the plurality of bus subscribers 805, 905.

A second step 310 of the method for configuring a replacement bus subscriber 815, 915, 917, 919, 1000, 1100, 1200 according to the first embodiment 300 comprises writing a replacement object for setting a function, i.e. a mode of operation of the replacement bus subscriber 815, 915, 917, 919, 1000, 1100, 1200 with respect to the at least one original bus subscriber that the replacement bus subscriber 815, 915, 917, 919, 1000, 1100, 1200, by sending a further data packet, e.g. a fourth data packet, to the plurality of bus subscribers 805, 905. The replacement object may form a third communication object comprising at least one data field, or the replacement object may be embodied as the above-mentioned first identification object, i.e. the communication object comprising the above-mentioned one or a plurality of data fields for identifying a bus subscriber.

If the replacement object is embodied as a separate third communication object, then in the configuration method according to the first embodiment 300, only the replacement object is written, while the identification object may be read as the first communication object. If the replacement object and the identification object form the same communication object, e.g. the same first communication object, then this first communication object may be read, e.g. as part of the application of the method for recognizing a replacement bus subscriber 815, 915, 917, 919, 1000, 1100, 1200 according to the first and second embodiments 100, 200 in FIGS. 1 and 2, e.g. with the aid of the above-mentioned first data packet or with the aid of the above-mentioned second and third data packets, and then written within the framework of the configuration method according to the first embodiment 300. The writing may e.g. be carried out based on the fourth data packet, which is transmitted, for example, by the control bus subscriber 830, 930 as the sender to the plurality of bus subscribers 805, 905.

For example, the replacement object or identification object could be written in accordance with the replacement list 833 of the replacement bus subscriber 815 in FIG. 8 to: product identifier PC2 and the first data word of the version number RL2. Similarly, the replacement bus subscribers 915, 917, 919 in FIG. 9 may be handled in the same way. For the values to be written for the replacement objects or the identification objects, reference is made to the replacement lists 933, 937, 939 of the replacement bus subscribers 915, 917, 919 in FIG. 9 (see description above). In the context of the above application example, this could mean that the replacement bus subscriber 815, which is embodied as a multifunction terminal, is set up with regard to its comprehensive interfaces in such a way that, for example, two digital inputs are activated, provided that the original bus subscriber as mentioned above, was embodied, for example, as an input terminal with two comprehensive digital inputs. The other interfaces of the replacement bus subscriber 815 embodied as a multifunction terminal, e.g. outputs, could also be activated at a later time if necessary. These would be additional functions that the original bus subscriber does not include, for example.

Providing the target configuration in the first step 305 of the configuration method according to the first embodiment 300 in FIG. 3 may include sending the target configuration with the aid of a further, e.g. the fifth data packet, to the plurality of bus subscribers 805, 905 of the automation network 800, 900 with the aid of the control bus subscriber 830, 930. This is particularly conceivable if the configuration method according to the first embodiment 300 has been carried out without prior detection of the bus subscribers, i.e. without detection of a replacement bus subscriber 815, 915, 917, 919, 1000, 1100, 1200, so that the individual bus subscribers may carry out the comparison between the target and actual configuration themselves.

As already mentioned, before writing the replacement object or the identification object in the second step 310 of the configuration method according to the first embodiment 300, the method for detecting a replacement bus subscriber 815, 915, 917, 919, 1000, 1100, 1200 according to the first and second embodiments 100, 200 may be carried out according to the features described above for determining the actual configuration of the automation network 800, 900.

If the replacement object or the identification object has been written to a bus subscriber that is not embodied as a replacement bus subscriber 815, 915, 917, 919, 1000, 1100, 1200, the configuration of the function of this bus subscriber remains unchanged. In other words, this means that the execution of the configuration method according to the first embodiment 300 in FIG. 3 specifically only affects a replacement bus subscriber 815, 915, 917, 919, 1000, 1100, 1200, and not other bus subscribers.

Unlike FIG. 3, FIG. 4 shows a combination of the method for detecting a replacement bus subscriber 815, 915, 917, 919, 1000, 1100, 1200 according to the second embodiment 200 in FIG. 2 and the above-described method for configuring the replacement bus subscriber 815, 915, 917, 919, 1000, 1100, 1200 according to the first embodiment 300 in a configuration method according to the second embodiment 400 with higher detail resolution. The first step 405 and the second step 410 of the configuration method according to the second embodiment 400 may be similar to the first and second steps 305, 310 of the configuration method according to the first embodiment 300 in FIG. 3. Therefore, reference is made to the above description.

Between the first and second step 405, 410 of the method for configuring according to the second embodiment 400, the individual steps of the method for detecting a replacement bus subscriber 815, 915, 917, 919, 1000, 1100, 1200 according to the second embodiment 200 may be carried out. If the target configuration is in the replacement list 833, 933, 937, 939 of the respective replacement bus subscriber 815, 915, 917, 919, 1000, 1100, 1200 in FIGS. 8 and 9, or the target configuration matches the replacement list 833, 933, 937, 939, and the replacement bus subscriber 815, 915, 917, 919, 1000, 1100, 1200 has been identified as such, the second step 410 of the configuration method according to the second embodiment 400 is carried out, i.e. writing the replacement object or the identification object, e.g. with the aid of the control bus subscriber 830, 930. If the target configuration is not found in the respective replacement list 833, 933, 937, 939 of the corresponding replacement bus subscriber 815, 915, 917, 919, 1000, 1100, 1200, the fourth intermediate step 235 of the detection method according to the second embodiment 200 would be carried out, namely the error message would be generated and the control bus subscriber 830, 930 would, for example, abort the initializing phase 201.

If the second step 410 of the configuration method according to the second embodiment 400 has been successfully carried out, then, for example, the control bus subscriber 830, 930 may carry out the fourth step 245 of the method for detecting a replacement bus subscriber 815, 915, 917, 919, 1000, 1100, 1200 according to the second embodiment 200, i.e. continue the initializing phase 201 with the next bus subscriber.

A first and second step 505, 510 of the method for configuring a replacement bus subscriber 815, 915, 917, 919, 1000, 1100, 1200 according to the third embodiment 500 in FIG. 5 may be similar to the first and second steps 305, 310 of the method 300 for configuring a replacement bus subscriber 815, 915, 917, 919, 1000, 1100, 1200 according to the first embodiment 300 in FIG. 3, therefore reference is made to the above description. It is conceivable that the replacement object or the identification object in the second step 510 of the method for configuring a replacement bus subscriber 815, 915, 917, 919, 1000, 1100, 1200 according to the third embodiment 500 and no method for recognizing a replacement bus subscriber 815, 915, 917, 919, 1000, 1100, 1200 according to the first and second embodiments 100, 200 according to the above-mentioned features has been implemented. In this case, the replacement bus subscriber 815, 915, 917, 919, 1000, 1100, 1200 may be embodied to check the support of the function of at least one original bus subscriber, e.g., taking into account the replacement object or the identification object in a third step 515 of the configuration method according to the third embodiment 500. This may be done, for example, by reading or comparing with the replacement list 833, 933, 937, 939 of the corresponding replacement bus subscriber 815, 915, 917, 919, 1000, 1100, 1200. The third step 515 of the configuration method according to the third embodiment 500 may form a branch here.

The replacement bus subscriber 815, 915, 917, 919, 1000, 1100, 1200 may, in a fourth step 517 of the configuration method according to the third embodiment 500, transmit a confirmation 517 of the configuration of the function of the replacement bus subscriber 815, 915, 917, 919, 1000, 1100, 1200 to the control bus subscriber 830, 930, provided that the check of the replacement object or of the identification object in the third step 515 of the configuration method according to the third embodiment 500 was successful (j-branch of the third step 515 of the method according to the third embodiment 500). It is also conceivable that the replacement bus subscriber 815, 915, 917, 919, 1000, 1100, 1200 activates the function according to the replacement object. Otherwise (n-branch of the third step 515 of the method according to the third embodiment 500), the replacement bus subscriber 815, 915, 917, 919, 1000, 1100, 1200 may carry out a fifth step 535 of the method according to the third embodiment 500, i.e., transmit an error message to the control bus subscriber 830, 930.

FIGS. 6 and 7 are described in combination below. FIG. 6 shows a schematic depiction of a method for activating a function, i.e. an operating mode of a replacement bus subscriber 815, 915, 917, 919, 1000, 1100, 1200 according to a first embodiment 600, and FIG. 7 shows a schematic depiction of a method for activating a function, i.e. an operating mode of a replacement bus subscriber 815, 915, 917, 919, 1000, 1100, 1200 according to a second embodiment 700. The two methods for activating the function according to the first and second embodiments 600, 700 may e.g. be carried out by the replacement bus subscribers 815, 915, 917, 919, 1000, 1100, 1200 as receivers.

The methods for activating a function according to the first and second embodiments 600, 700 each comprise, in a first step 605, 705, receiving a replacement object (write). The writing of the replacement object for the corresponding replacement bus subscriber 815, 915, 917, 919, 1000, 1100, 1200 may e.g. be carried out with the aid of the above-mentioned fourth data packet. However, this is not to be understood as restrictive. In this case, the replacement object may form the third communication object mentioned above, which comprises at least one data field for setting the function of the replacement bus subscriber 815, 915, 917, 919, 1000, 1100, 1200 with respect to at least one original bus subscriber, and/or the replacement object may be embodied as the identification object and form the same first communication object according to the above features with one or a plurality of data fields for identifying a bus subscriber. Reference is made to the above description at this point.

In a second step 610, 710 of the methods for activating a function according to the first and second embodiments 600, 700, the replacement bus subscriber 815, 915, 917, 919, 1000, 1100, 1200 may check whether the replacement bus subscriber 815, 915, 917, 919, 1000, 1100, 1200 supports a function of at least one original bus subscriber. This check may be carried out, for example, taking into account the replacement object and/or the identification object. The checking in the second step 610, 710 of the methods for activating a function according to the first and second embodiments 600, 700 is shown as a branch in FIGS. 6 and 7. If the checking in the second step 610, 710 of the methods for activation according to the first and second embodiments 600, 700, i.e. the branches in FIGS. 6 and 7, has been successfully carried out (j-branch of the second step 610, 710 of the activation methods according to the first and second embodiments 600, 700), a replacement bus subscriber 815, 915, 917, 919, 1000, 1100, 1200 may activate the function of the replacement bus subscriber 815, 915, 917, 919, 1000, 1100, 1200 according to the replacement object and/or according to the identification object. The function may be activated, for example, as described in connection with FIGS. 3 to 5, i.e. the activation may e.g. comprise the two digital inputs of the replacement bus subscriber 815 embodied as a multifunction terminal for the original bus subscriber, for example, which may be embodied as an input terminal (comprising two digital inputs), for example.

If the replacement bus subscriber 815, 915, 917, 919, 1000, 1100, 1200 determines during the check in the second step 610, 710 of the activation methods 600, 700 that it does not support the function of the at least one original bus subscriber (n-branch of the second step 610, 710 of the methods 600, 700), the replacement bus subscriber 815, 915, 917, 919, 1000, 1100, 1200 may carry out a fourth step 635 of the activation method according to the first embodiment 600 or a fifth step 735 of the activation method according to the second embodiment 700, each of which may comprise an error message, e.g. to the control bus subscriber 830, 930. The error message may be transmitted via the bus system 810, 910, i.e. the field bus, e.g. the EtherCAT field bus.

The activation method according to the second embodiment 700 in FIG. 7 differs from the activation method according to the first embodiment 600 in FIG. 6 only in that it comprises a fourth step 717 following the third step 715 of the activation method according to the second embodiment 700, wherein the fourth step 717 comprises sending a confirmation of the activation of the function of the replacement bus subscriber 815, 915, 917, 919, 1000, 1100, 1200.

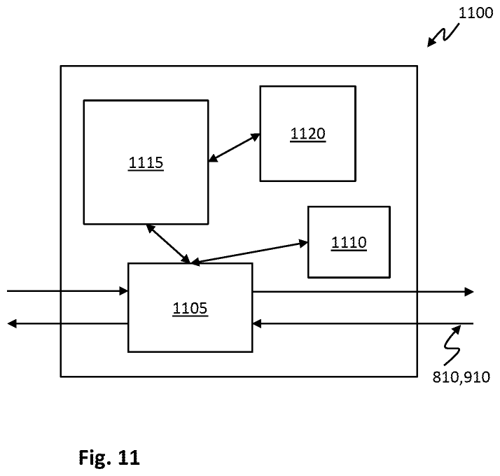

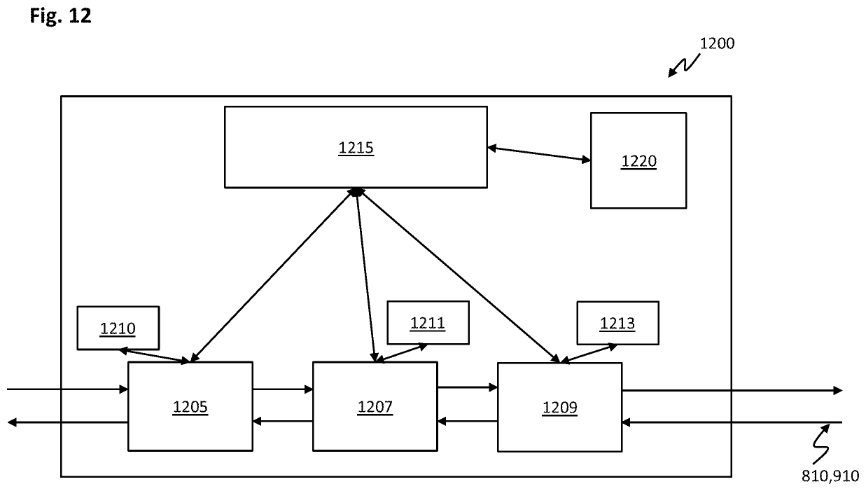

FIGS. 10 to 12 are described together below. FIG. 10 shows a schematic depiction of a replacement bus subscriber 1000 according to a first embodiment, FIG. 11 shows a schematic depiction of a replacement bus subscriber 1100 according to a second embodiment, and FIG. 12 shows a schematic depiction of a replacement bus subscriber 1200 according to a third embodiment. For example, the replacement bus subscribers 1000, 1100 according to the structure of FIGS. 10 and 11 may be used in the automation network 800 in FIG. 8 to replace a single original bus subscriber, while the replacement bus subscriber 1200 according to the structure of FIG. 12 may be used in the automation network 900 in FIG. 9 to functionally replace multiple original bus subscribers.

The replacement bus subscriber with the structure according to the first to third embodiments 1000, 1100, 1200 in FIGS. 10 to 12 comprises at least one communication unit 1005, 1105, 1205, 1207, 1209, which is communicatively connected to at least one memory unit 1010, 1110, 1210, 1211, 1213 of the replacement bus subscriber according to the first to third embodiments 1000, 1100, 1200. Specifically, the replacement bus subscribers according to the first and second embodiments 1000, 1100 in FIGS. 10 and 11 each comprise a communication unit 1005, 1105, while the replacement bus subscriber according to the third embodiment 1200 in FIG. 12 comprises, for example, a first to third communication unit 1205, 1207, 1209 in order to be able to replace a first to third original bus subscriber. It goes without saying that in the case of a different implementation, i.e. when more than three original bus subscribers are replaced by a replacement bus subscriber 915, 917, 919 or fewer than three original bus subscribers, the number of communication units 1205, 1207, 1209 in FIG. 12 may also vary.

The memory unit 1010, 1110, 1210, 1211, 1213 e.g. comprises a non-volatile memory and may e.g. be embodied as a so-called ESI-EEPROM. The replacement bus subscribers according to the first and second embodiments 1000, 1100 in FIGS. 10 and 11 each comprise a memory unit 1010 embodied as an ESI-EEPROM, 1110, and the replacement bus subscriber according to the third embodiment 1200 in FIG. 12 comprises three memory units 1210, 1211, 1213 embodied as ESI-EEPROMs.

The communication unit 1005, 1105, 1205, 1207, 1209 of the replacement bus subscribers according to the first to third embodiments 1000, 1100, 1200 is communicatively connected to the bus system 810, 910. The communicative connection may allow for bidirectional communication between the bus subscribers. In the event that the bus system is embodied as a field-bus system, and in particular as an EtherCAT field-bus system, or the automation network 800, 900 is embodied as an EtherCAT automation network, the communication units 1005, 1105, 1205, 1207, 1209 of the replacement bus subscribers according to the first to third embodiments 1000, 1100, 1200 are embodied as EtherCAT SubDevice Controllers (ESC for short).

The replacement bus subscriber according to the second and third embodiments 1100, 1200 in FIGS. 11 and 12 also comprises a microcontroller unit 1115, 1215, in contrast to the replacement bus subscriber according to the first embodiment 1000 in FIG. 10. The microcontroller unit 1115, 1215 may be embodied as a microcontroller (uC for short) or comprise a microcontroller. The microcontroller unit 1115, 1215 is communicatively connected to the communication unit 1105, 1205, 1207, 1209 for checking the support of the function of at least one original bus subscriber, e.g. taking into account the replacement object in accordance with the methods for activating a function according to the first and second embodiments 600, 700 in FIGS. 6 and 7, and for writing the replacement object and/or the identification object. In other words, the check in the second step 610, 710 of the activation methods according to the first and second embodiments 600, 700 is carried out by the microcontroller unit 1115, 1215. The communicative connection between the microcontroller unit 1115, 1215 and the communication unit 1105, 1205, 1207, 1209 may be established via a serial or parallel interface on the communication unit 1105, 1205, 1207, 1209. The replacement bus subscriber according to the first embodiment 1000 does not comprise a microcontroller unit, therefore the replacement object or the identification object in this case may be implemented more simply than in the above description, for example.

Preferred are the replacement bus subscriber 815 in FIG. 8 and the first to third replacement bus subscribers 915, 917, 919 in FIG. 9 are preferably embodied in accordance with FIG. 11 (for the replacement bus subscriber 815 in FIG. 8) and in accordance with FIG. 12 (for the first to third replacement bus subscribers 915, 917, 919 in FIG. 9).

The replacement bus subscriber according to the second and third embodiments 1100, 1200 in FIGS. 11 and 12 each comprise an object directory 1120, 1220, wherein the identification object and/or the replacement object may be stored in the object directory 1120, 1220 as a communication object to be written or as independent communication objects to be written. The type identifier may also be stored in the object directory 1120, 1200 if it is embodied as an independent second communication object. Furthermore, the replacement list 833, 933, 937, 939 may be stored in the object directory 1120, 1200. For example, the object directory 1120, 1220 may be part of the microcontroller unit 1115, 1215, wherein the microcontroller unit 1115, 1215 may e.g. comprise a microcontroller memory that comprises the object directory 1120, 1220.

It goes without saying that the original bus subscribers may have a similar structure to the replacement bus subscriber according to the first embodiment 1000 in FIG. 10 or to the replacement bus subscriber according to the second embodiment 1100 in FIG. 11.

The replacement bus subscribers 815, 915, 917, 919, 1000, 1100, 1200 shown in FIGS. 8 to 12 may each be embodied as subordinate devices, i.e., as subordinate bus subscribers that may be controlled by a main device, i.e., the control bus subscriber 830, 930. If the replacement bus subscriber 815, 915, 917, 919, 1000, 1100, 1200 is embodied as a subordinate device, the communication unit 1005, 1105, 1205, 1207, 1209 is embodied as an EtherCAT SubDevice Controller (ESC), as already mentioned.

The replacement bus subscriber shown in FIG. 12 according to the third embodiment 1200 may e.g. form a terminal with a plurality of physical connections (interfaces). However, it goes without saying that the replacement bus subscriber 815, 915, 917, 919, 1000, 1100, 1200 according to the third embodiment 1200 is not limited to the described embodiment.

Determining the actual configuration in the second step 110, 210 of the methods for recognizing a replacement bus subscriber 815, 915, 917, 919, 1000, 1100, 1200 according to the first and second embodiments 100, 200 in FIGS. 1, 2, which is carried out by reading the first data field and/or the second data field and/or the third data field of the identification object, may preferably be carried out by reading the memory unit 1110, 1210, 1211, 1213, e.g., with the aid of a first data packet, which comprises the identification object.

It is also conceivable to use the combined method for configuring a replacement bus subscriber 815, 915, 917, 919, 1000, 1100, 1200 according to the second embodiment 400 in FIG. 4, which also comprises steps of the method for recognizing a replacement bus subscriber 815, 915, 917, 919, 1000, 1100, 1200 according to the second embodiment 200 by reading the memory unit 1110, 1210, 1211, 1213 embodied as ESI-EEPROM, as described above. It is also conceivable to read the type identifier, e.g. in the second intermediate step 220 of the method 200 for recognizing a replacement bus subscriber 815, 915, 917, 919, 1000, 1100, 1200 according to the second embodiment 200 in FIG. 2 by reading the memory unit 1110, 1210, 1211, 1213 embodied as an ESI EEPROM. The same applies to the method for configuring a replacement bus subscriber 815, 915, 917, 919, 1000, 1100, 1200 according to the second embodiment 400 in FIG. 4, comprising the second intermediate step 220. It is also conceivable to read the replacement list 833, 933, 937, 939 in the third intermediate step 230 of the method for detecting a replacement bus subscriber 815, 915, 917, 919, 1000, 1100, 1200 according to the second embodiment 200, 400 in FIG. 2 by reading the memory unit 1110, 1210, 1211, 1213 embodied as ESI-EEPROM. The same applies to the method for configuring a replacement bus subscriber 815, 915, 917, 919, 1000, 1100, 1200 according to the second embodiment 400 in FIG. 4, comprising the third intermediate step 230.

The replacement list 833, 933, 937, 939 may alternatively also be stored in the object directory 1120, 1220. In this alternative, when reading the replacement list 833, 933, 937, 939 would be read instead of the memory unit 1110, 1210, 1211, 1213 embodied as ESI-EEPROM.

The writing of the replacement object and/or the identification object, e.g. in the second step 410 of the method for configuring a replacement bus subscriber 815, 915, 917, 919, 1000, 1100, 1200 according to the second embodiment 400 in FIG. 4, may be carried out from the object directory 1120, 1220, e.g. by the control bus subscriber 830, 930. Alternatively, the writing of the replacement object and/or the identification object could also be carried out, for example, in the second step 410 of the method for configuring a replacement bus subscriber 815, 915, 917, 919, 1000, 1100, 1200 according to the second embodiment 400 in FIG. 4, the writing of the memory unit 1110, 1210, 1211, 1213, which is embodied, for example, as an ESI-EEPROM, could also be included.

The invention has been described in detail with the aid of preferred embodiments. Instead of the embodiments described, other embodiments are conceivable which may have further modifications or combinations of the features described. For this reason, the invention is not limited by the disclosed examples, since other variations may be derived from them by a person skilled in the art without leaving the protective scope of the invention.

TABLE 1
List of reference numerals: 100-735

100 method for detecting a replacement bus subscriber according
to a first embodiment
105 first step
110 second step
115 third step
200 method for detecting a replacement bus subscriber according
to a second embodiment
201 initializing phase
205 first step
210 second step
215 first intermediate step
220 second intermediate step
230 third intermediate step
235 fourth intermediate step
240 third step
245 fourth step
300 method for configuring a replacement bus subscriber
according to a first embodiment
305 first step
310 second step
400 method for configuring a replacement bus subscriber
according to a second embodiment
405 first step
410 second step
500 method for configuring a replacement bus subscriber
according to a third embodiment
505 first step
510 second step
515 third step
517 fourth step
535 fifth step
600 method for activating a function, i.e., a mode of operation
of a replacement bus subscriber according to a first embodiment
605 first step
610 second step
615 third step
635 fourth step
700 method for activating a function, i.e. a mode of operation
of a replacement bus subscriber according to a second
embodiment
705 first step
710 second step
715 third step
717 fourth step
735 fifth step

TABLE 2
List of reference numerals: 800-1220

800 automation network according to a first embodiment
805 plurality of bus subscribers
810 bus system
815 replacement bus subscribers
820 first original bus subscriber
825 second original bus subscriber
830 control bus subscriber
833 replacement list
900 automation network according to a second embodiment
905 plurality of bus subscribers
910 bus system
915 first replacement bus subscriber
917 second replacement bus subscriber
919 third replacement bus subscriber
930 control bus subscriber
933 first replacement list
937 second replacement list
939 third replacement list
1000 replacement bus subscribers according to a first embodiment
1005 communication unit
1010 memory unit
1100 replacement bus subscriber according to a second embodiment
1105 communication unit
1110 memory unit
1115 microcontroller unit
1120 object directory
1200 replacement bus subscriber according to a third embodiment
1205 first communication unit
1207 second communication unit
1209 third communication unit
1210 first memory unit
1211 second memory unit
1213 third memory unit
1215 microcontroller unit
1220 object directory

1. A method for initializing an automation network comprising a plurality of bus subscribers, the method comprising the steps of:
providing a target configuration of the automation network, which contains identification objects assigned to the bus subscribers, and
determining an actual configuration of the automation network;
wherein for each bus subscriber, the identification object associated with the bus subscriber in the target configuration is compared to an identification object read out from the bus subscriber,
wherein, if a deviation exists between the identification objects, it is determined on the basis of a type identifier read out from the bus subscriber whether the bus subscriber is a replacement bus subscriber, and
wherein, if the type identifier indicates that the bus subscriber is a replacement bus subscriber, it is determined on the basis of a replacement list read out from the bus subscriber whether an original bus subscriber is replaceable by the replacement bus subscriber; and
triggering an error state and aborting the initialization if no permitted actual configuration is determined when determining the actual configuration.

2. The method according to claim 1, wherein the replacement list specifies which of the bus subscribers are functionally replaceable by a replacement bus subscriber.

3. The method according to claim 1, wherein if the replacement list indicates that the replacement bus subscriber can replace the original bus subscriber, a replacement object that determines how the replacement bus subscriber is to function, with regard to functions of the original bus subscriber, is written into the replacement bus subscriber.

4. The method according to claim 3, wherein the replacement object comprises the identification object of the original bus subscriber that the replacement bus subscriber replaces.

5. The method according to claim 1, wherein:
the identification object forms a first communication object comprising one or a plurality of data fields for identifying a bus subscriber, and
wherein the identification object comprises as a data field a product identifier of the bus subscriber, a version number of the bus subscriber, and/or a manufacturer identifier of the bus subscriber.

6. The method according to claim 5, wherein:
a data field of the identification object is embodied as a version number of the bus subscriber,
wherein the version number comprises a first data word and a second data word,
wherein the replacement bus subscriber contains a data field with a version number in the replacement list, wherein the version number comprises a first data word and a second data word, and
wherein a version number comparison is carried out between the original bus subscriber and the replacement bus subscriber, wherein, if the original bus subscriber is replaceable by the replacement bus subscriber, the first data word must match and the second data word is larger than or equal to in the actual configuration than in the target configuration.

7. An automation network comprising a plurality of bus subscribers that are communicatively connected to one another via a bus system, wherein:
at least one bus subscriber of the plurality of bus subscribers is configured as a replacement bus subscriber for replacing an original bus subscriber,
wherein during an initializing phase of the automation network, a control bus subscriber checks the conformity of a target and an actual configuration of the bus subscribers by reading out identification objects of the bus subscribers,
wherein for each bus subscriber, the identification object associated with the bus subscriber in the target configuration is compared to an identification object read out from the bus subscriber,
wherein, if a deviation exists between the identification objects, it is determined on the basis of a type identifier read out from the bus subscriber whether the bus subscriber is a replacement bus subscriber, and
wherein, if the type identifier indicates that the bus subscriber is a replacement bus subscriber, it is determined on the basis of a replacement list read out from the bus subscriber whether the original bus subscriber is replaceable by the replacement bus subscriber, triggering an error state and aborting the initialization if no permitted actual configuration is determined when determining the actual configuration.

8. The automation network according to claim 7, wherein the automation network forms an EtherCAT automation network.

9. The automation network according to claim 7, wherein:
the replacement bus subscriber comprises at least one communication unit that is communicatively connected to at least one storage unit of the replacement bus subscriber, wherein the memory unit comprises a non-volatile memory, and
wherein the communication unit is communicatively connected to a bus system.

10. The automation network according to claim 9, wherein:
the replacement bus subscriber further comprises a microcontroller unit communicatively connected to the communication unit for checking the replacement object and/or the identification object, and
wherein the replacement bus subscriber comprises an object directory, wherein the identification object and/or the replacement object can be stored in the object directory.

11. A method for initializing an automation network, wherein the automation network comprises a plurality of bus subscribers, the method comprising:
providing a target configuration of the automation network, which contains identification objects assigned to the bus subscribers, and
determining an actual configuration of the automation network;
wherein for each bus subscriber, the identification object associated with the bus subscriber in the target configuration is compared to an identification object read out from the bus subscriber,
wherein, if a deviation exists between the identification objects, it is determined on the basis of a type identifier read out from the bus subscriber whether the bus subscriber is a replacement bus subscriber,
wherein, if the type identifier indicates that the bus subscriber is a replacement bus subscriber, it is determined on the basis of a replacement list read out from the replacement bus subscriber whether an original bus subscriber is replaceable by the replacement bus subscriber, wherein the replacement list specifies which of the bus subscribers are functionally replaceable by a replacement bus subscriber, and
wherein, if the replacement list indicates that the replacement bus subscriber can replace the original bus subscriber, a replacement object that determines how the replacement bus subscriber is to function, with regard to functions of the original bus subscriber, is written into the replacement bus subscriber; and
triggering an error state and aborting the initialization if no permitted actual configuration is determined when determining the actual configuration.

12. The method according to claim 11, wherein the replacement object comprises the identification object of the original bus subscriber that the replacement bus subscriber replaces.

13. The method according to claim 11, wherein:
the identification object forms a first communication object comprising one or a plurality of data fields for identifying a bus subscriber, and
wherein the identification object comprises as a data field a product identifier of the bus subscriber, a version number of the bus subscriber, and/or a manufacturer identifier of the bus subscriber.

14. The method according to claim 13, wherein:
a data field of the identification object is embodied as a version number of the bus subscriber, wherein the version number comprises a first data word and a second data word,
wherein the replacement bus subscriber contains a data field with a version number in the replacement list, wherein the version number comprises a first data word and a second data word, and
wherein a version number comparison is carried out between the original bus subscriber and the replacement bus subscriber;
wherein, if the original bus subscriber is replaceable by the replacement bus subscriber, the first data word must match and the second data word is larger than or equal to in the actual configuration than in the target configuration.

15. A replacement bus subscriber for replacing an original bus subscriber for an automation network, configured to carry out the method of claim 11.

16. The replacement bus subscriber according to claim 15, wherein:
the replacement bus subscriber comprises at least one communication unit that is communicatively connected to at least one storage unit of the replacement bus subscriber, wherein the memory unit comprises a non-volatile memory, and
wherein the communication unit is communicatively connected to a bus system.

17. A replacement bus subscriber according to claim 16, wherein:
the replacement bus subscriber further comprises a microcontroller unit communicatively connected to the communication unit for checking the replacement object and/or the identification object, and
wherein the replacement bus subscriber comprises an object directory, wherein the identification object and/or the replacement object can be stored in the object directory.

18. An automation network comprising a plurality of bus subscribers that are communicatively connected to one another via a bus system, wherein at least one bus subscriber of the plurality of bus subscribers is configured as a replacement bus subscriber for replacing an original bus subscriber according to claim 15.

19. The automation network according to claim 18, wherein during the initializing phase of the automation network, a control bus subscriber checks the conformity of the target and actual configuration of the bus subscribers by reading out the identification objects of the bus subscribers.

20. The automation network according to claim 19, wherein the automation network forms an EtherCAT automation network.
